(19) United States
(12) Patent Application Publication
(10) Pub. No.: US 2022/0101018 A1
(43) Pub. Date: Mar. 31, 2022

(54) SYSTEMS AND METHODS FOR EFFICIENT DATA COMMUNICATIONS IN TRAFFIC MONITORING

(71) Applicant: Rekor Systems, Inc., Columbia, MD (US)

(72) Inventors: Christopher Allen KADOCH, Leesburg, VA (US); Jason SKIPPER, Sanford, FL (US); Matthew Anthony HILL, Sanford, NC (US)

(21) Appl. No.: 17/489,902

(22) Filed: Sep. 30, 2021

Related U.S. Application Data
(60) Provisional application No. 63/085,800, filed on Sep. 30, 2020.

(51) Int. Cl. G06K 9/00; G06K 9/62; H04L 29/08

(52) U.S. Cl. CPC G06K 9/00785; G06K 9/6201; G06K 2209/15; G06K 2209/23; H04L 67/12

(57) ABSTRACT

A traffic monitoring system includes a traffic sensor having an imaging unit that generates a recognition record by image recognition processing a captured image of a vehicle. The recognition record includes primary data and additional data. The traffic sensor also includes a transceiver that transmits the primary data and the additional data to a server system. The additional data is transmitted in response to a request from the server system received by the traffic sensor after the primary data is transmitted. The server system transmits the request to the traffic sensor based on the primary data received from the traffic sensor.

### CROSS-REFERENCE TO RELATED APPLICATIONS

This application claims the benefit of U.S. Provisional Application No. 63/085,800, filed Sep. 30, 2020, the disclosures of which are expressly incorporated by reference herein.

### BACKGROUND

The present invention relates to traffic monitoring systems and methods, and more particularly to such systems and methods that reduce the operational load on the communications infrastructure via the use of evidence rules-based transfer protocols.

Automated license plate readers, have been used by law enforcement to monitor roadways for vehicles of interest to law enforcement—e.g., vehicles owned by persons suspected of committing crimes. Imaging devices capture images of license plates, and image recognition software produces a read-record that identifies the license plate number for comparison to a hot list of vehicles-of-interest. The vehicles-of-interest may be vehicles connected to individuals on criminal wanted lists, terrorist watch lists, scofflaw lists, outstanding warrant lists, etc., or may be identified as stolen, as registration-expired, etc. This comparison of read-records with hot lists generally occurs at a central system server that collects the read-records.

Imaging devices can also capture additional information, such as video clips, panoramic images, etc., that is of value to law-enforcement, particularly in verifying “hits” of the hot lists. However, history tells us that less than 0.5% of the all the law enforcement collected video data is ever reviewed. Thus, as the additional information becomes increasingly data intensive—for example, where rich media is being generated—so does the data transmission to the system server become increasingly costly and inefficient.

It is therefore desirable to provide a traffic monitoring system that reduces the operational load on the communications infrastructure while making this additional information available as needed.

### BRIEF SUMMARY OF THE INVENTION

Systems and methods are disclosed for a traffic monitoring system that reduces the operational load on the communications infrastructure while making additional information available as needed. In at least one embodiment, the traffic monitoring system includes a traffic sensor and a server system remote therefrom. The traffic sensor can have an imaging unit that generates a recognition record by image recognition processing a captured image of a vehicle. The recognition record can include primary data and additional data. The traffic sensor can also have a transceiver that transmits the primary data and the additional data to a remote server system. The additional data can be transmitted in response to a request from the remote server system received by the traffic sensor after the primary data is transmitted. The server system can transmit the request to the traffic sensor based on the primary data received from the traffic sensor. The operational load on the communications infrastructure can accordingly be reduced without restricting the availability of the additional data.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples.

### BRIEF DESCRIPTION OF THE DRAWINGS

The features, objects, and advantages of the present invention will become more apparent from the detailed description, set forth below, when taken in conjunction with the drawings, in which like reference characters identify elements correspondingly throughout.

FIG. 1 illustrates an exemplary traffic monitoring system in accordance with at least one embodiment of the invention.

FIG. 2 illustrates an exemplary method for traffic monitoring in accordance with at least one embodiment of the invention.

### DETAILED DESCRIPTION OF THE PREFERRED EMBODIMENTS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

The present invention generally relates to traffic monitoring systems and methods, and more particularly to such systems and methods for reducing the operational load on the communications infrastructure of the system.

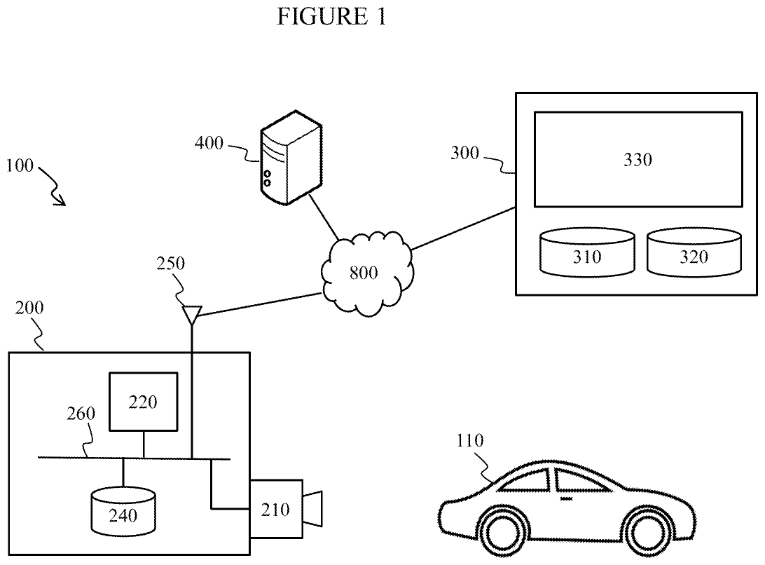

FIG. 1 is a schematic representation of a traffic monitoring system 100 in accordance with one or more aspects of the invention. As shown in FIG. 1, the traffic monitoring system 100 comprises one or more traffic sensors 200 communicatively coupled to a system server 300, via a network 800. In general, the traffic monitoring system 100 enables the collection of traffic related data for transmission to a law-enforcement server 400, via the network 800.

Each traffic sensor 200 comprises an imaging device 210, an image processing unit 220, a memory 240, and a transceiver 250, each communicatively coupled to a common data bus 260 that enables data communication between the respective components.

The imaging device 210 captures images of traffic, in particular, video images of vehicles 110 making up the traffic, and generates video data therefrom. The imaging device 210 may be a video camera of any camera type, which captures video images suitable for computerized image recognition of objects within the captured images. For example, the camera may utilize charge-coupled-device (CCD), complementary metal-oxide-semiconductor (CMOS) and/or other imaging technology, to capture standard, night-vision, infrared, and/or other types of images, having predetermined resolution, contrast, color depth, and/or other image characteristics. The video data may be timestamped so as to indicate the date and time of recording.

The image processing unit 220 applies computerized image recognition techniques to the video data captured by the imaging device 210 so as to identify objects within the video images. In particular, the image processing unit 220 identifies individual vehicles captured by the video images, as well as their associated characteristics. These vehicle characteristics may include, for example, vehicle type, class, make, model, color, year, drive type (e.g., electric, hybrid, etc.), license plate number, registration, trajectory, speed, location, etc., or any combination thereof.

The image processing unit 220 generates a recognition record for each recognized vehicle from the recognized vehicle characteristics. The recognition record is preferably a dataset of image recognized values for one or more of the vehicle characteristics, i.e., characteristic data. For example, the characteristic data for the license plate number characteristic is the image recognized license plate number for the recognized vehicle. In at least one embodiment, the recognition record is at least the license plate number. However, the recognition record can include any subset of the characteristic data. In at least one embodiment, the recognition record may also include the timestamp of the associated video data from which the recognition record is generated, and one or more images of the vehicle and/or the license plate. The recognition record is preferably in the form of a data object whose value is the license plate number, and whose metadata reflects the remainder of the characteristic values, if any. The recognition record is retrievably stored in the memory 240 until deletion.

The image processing unit 220 also generates a reduced record for transmission to the system server. The reduced record is a subset of the recognition record data, and preferably includes only that data which is necessary for comparison to one or more hot lists stored at the system server. For example, the reduced record may consist solely of the license plate number, or may also include one or more of: the timestamp, the image of the license plate, and a limited (e.g., close cropped) image of the vehicle. In some embodiments, the reduced record may include low-resolution and/or limited frame video/image data that is otherwise high-resolution and/or full frame in the non-reduced recognition record. As such, the reduced record may have a reduced data size when compared to the recognition record as a whole.

In operation, the reduced record may be transmitted to the system server 300 in lieu of the recognition record and associated data. The system server 300 may then compare the reduced record to the one or more hot lists to determine if the reduced record corresponds to a vehicle-of- interest listed in the one or more hot lists (i.e., the system server registers a “hit”). In the event of a hit, the system server 300 may request additional data from the traffic sensor 200, which may, in response retrieve the additional data from the memory 240 and transmit it to the system server 300. The additional data may be the recognition record, video data, image data, and/or any other data stored by the traffic sensor 330.

The image processing unit 220 may be embodied, collectively or individually, as one or more processors programmed to carry out the functions of the unit in accordance software stored in the memory 240. Each processor may be a standard processor, such as a central processing unit (CPU), graphics processing unit (GPU), or a dedicated processor, such as an application-specific integrated circuit (ASIC) or field programmable gate array (FPGA), or portion thereof.

The memory 240 stores software and data that can be accessed by the processor(s), and includes both transient and persistent storage. The transient storage is configured to temporarily store data being processed or otherwise acted on by other components, and may include a data cache, RAM or other transient storage types. The persistent storage is configured to store software and data until deleted.

In at least some embodiments, the memory 240 is configured to store the data and information described herein. In particular, the memory 240 stores the recognition records, and the associated image and video data, in accordance with one or more retention periods, after which the data is deleted. The retention periods may be set individually or respect to different categories of data. For example, the retention period for video data may be 30 days, whereas the retention period for specific characteristic data, such as license plate number, may be shorter.

The transceiver 250 communicatively couples the traffic sensor 200 to the network 800 so as to enable data transmission therewith. The network 800 may be any type of network, wired or wireless, configured to facilitate the communication and transmission of data, instructions, etc., and may include a local area network (LAN) (e.g., Ethernet or other IEEE 802.03 LAN technologies), Wi-Fi (e.g., IEEE 802.11 standards, wide area network (WAN), virtual private network (VPN), global area network (GAN)), a cellular network, or any other type of network or combination thereof.

In general, each server many include one or more server computers connected to the network 800. Each server computer may include computer components, including one or more processors, memories, displays and interfaces, and may also include software instructions and data for executing the functions of the server described herein. The servers may also include one or more storage devices configured to store large quantities of data and/or information, and may further include one or more databases. For example, the storage device may be a collection of storage components, or a mixed collection of storage components, such as ROM, RAM, hard-drives, solid-state drives, removable drives, network storage, virtual memory, cache, registers, etc., configured so that the server computers may access it. The storage components may also support one or more databases for the storage of data therein.

The system server 300 is generally configured to provide centralized support for the traffic sensors 200. The system server 300 is configured to receive recognition records, or portions thereof, including reduced records, from each of the traffic sensors 200, and to store the received recognition records.

The system server 300 includes one or more record databases 310 configured to store data received from the traffic sensors, and one or more hot list databases 320 each of which defines a hot list of vehicles-of-interest. Each hot list identifies respective vehicles-of-interest by one or more vehicle characteristics, preferably at least by their respective license plate numbers. In some embodiments, vehicles-of-interest may also be identified via one or more images, such as images of the vehicle or license plate. Hot lists may be provided to the system server 300 by law-enforcement, via transmission over the network from the law-enforcement server 400, and may be updated periodically or on an ad hoc basis.

The system server 300 also includes a comparison unit 330 configured to compare the characteristic data of the reduced records, or portions thereof, to each hot list. One or more data and/or image comparison techniques may be used by the comparison unit 330 to make the comparison. In at least one embodiment, the comparison unit 330 compares the license plate number provided by the reduced record to the license plate numbers identified in the hot list. Where the comparison unit 330 determines that the reduced record matches a listed vehicle-of-interest, the comparison unit 330 returns a hit notification, which identifies the hit and the associated reduced record.

The system server 300 may transmit the hit notification to the corresponding traffic sensor 200, which may process the hit notification as a request for additional data. The additional data may include the recognition record, image data and/or video data, or portions thereof. In some embodiments, the additional data includes a video clip of the vehicle-in-question, as well as an uncropped image of the vehicle and its surroundings. In response to the request, the traffic sensor 200 may retrieve the requested additional data from the memory 240, and transmit it to the server system for storage and retrieval by law-enforcement.

In some embodiments, the system server 300 may also be configured to transmit an ad hoc request for the additional data to the appropriate traffic sensor 200. In response, the traffic sensor 200 may retrieve the requested additional data from the memory 240, and transmit it to the server system for storage and retrieval by law-enforcement.

The comparison unit 330 may be embodied as one or more processors programmed to carry out the functions of the unit in accordance software stored in the memory. Each processor may be a standard processor, such as a central processing unit (CPU), or a dedicated processor, such as an application-specific integrated circuit (ASIC) or field programmable gate array (FPGA), or portion thereof.

The law-enforcement server 400 is a server of a law-enforcement agency, e.g., police, highway patrol, sheriff, or other local, state or federal law-enforcement agency, which is configured to send data to and receive data from the system server 300. In particular, the law-enforcement server 400 may add, delete or modify hot lists stored on the system server 300, in accordance with various permissions, as is known in the art.

Accordingly, an aspect of the invention is the ability to intelligently transfer data as required, so as to optimize bandwidth and limit data transfers to that data which is needed for a specific purpose (e.g., hot list comparison). Thus, the traditional “brute force” transfer of all data is avoided, but is still available “on the edge” for later transfer if and when it is required by the system. A virtual and distributed video management system is therefore enabled.

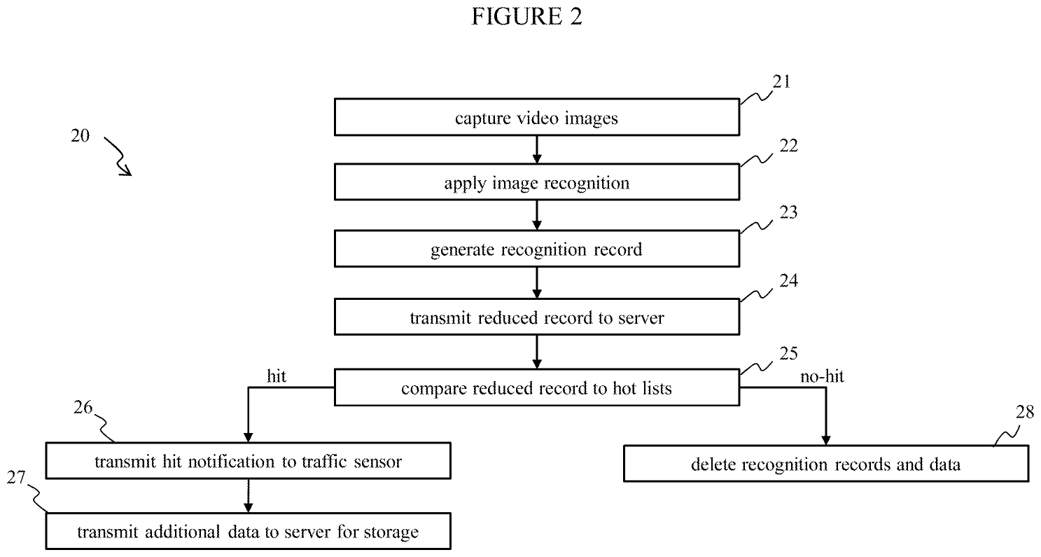

FIG. 2 is a flow-chart representing an exemplary method 20 of operation for the traffic monitoring system in accordance with one or more aspects of the invention.

In operation, at step 21, respective imaging devices 210 of a plurality of traffic sensors 200 capture images of vehicle traffic, namely, video images of passing vehicles, and generate video data therefrom. The traffic sensors 200 are preferably each positioned at various roadway locations where the vehicle traffic is to be monitored. The imaging devices 210 are preferably positioned such that the captured images include the respective license plates of the passing vehicles, as well as other vehicle characteristics, e.g., vehicle type, class, make, model, color, year, drive type, license plate number, registration, trajectory, speed, location, etc., or any combination thereof.

At step 22, the image processing unit 220 applies computerized image recognition techniques to the video data captured by the imaging device 210 so as to identify objects within the video images. The image processing unit 220 thereby identifies the presence of individual vehicles, as well as their license plates and one or more of their vehicle characteristics. The image processing unit 220 may utilize any image recognition software suitable for this purpose.

At step 23, the image processing unit 220 generates a recognition record for each recognized vehicle from the recognized vehicle characteristics. The recognition record is preferably a dataset of image recognized values for one or more of the vehicle characteristics, i.e., characteristic data. For example, the characteristic data for the license plate number characteristic is the image recognized license plate number for the recognized vehicle. In at least one embodiment, the recognition record is at least the license plate number. However, the recognition record can include any subset of the characteristic data. In at least one embodiment, the recognition record may also include the timestamp of the associated video data from which the recognition record is generated, and one or more images of the vehicle and/or the license plate. The recognition record is preferably in the form of a data object whose value is the license plate number, and whose metadata reflects the remainder of the characteristic values, if any. The recognition record is retrievably stored in the memory 240 until deletion.

At step 24, the image processing unit 220 generates a reduced record and transmits the reduced record to the system server 300. The reduced record is a subset of the recognition record data, and preferably includes only that data which is necessary for comparison to one or more hot lists stored at the system server. For example, the reduced record may consist solely of the license plate number, or may also include one or more of: the timestamp, the image of the license plate, and a limited (e.g., close cropped) image of the vehicle. As such, the reduced record has a reduced data size when compared to the recognition record as a whole. In particular, the reduced record may exclude rich media.

At step 25, the comparison unit 330 of the server system 300 compares the characteristic data of the reduced records to each hot list. One or more data and/or image comparison techniques may be used by the comparison unit 330 to make the comparison. In at least one embodiment, the comparison unit 330 compares the license plate number provided by the reduced record to the license plate numbers identified in the hot list.

At step 26, where the comparison unit 330 determines that the reduced record matches a listed vehicle-of-interest, the comparison unit 330 returns a hit notification, which identifies the hit and the associated reduced record. The hit notification is transmitted to the corresponding traffic sensor 200, which may process the hit notification as a request for additional data. The additional data may include the recognition record, image data and/or video data, or portions thereof. In some embodiments, the additional data includes a video clip of the vehicle-in-question, as well as an uncropped image of the vehicle and its surroundings. In particular, the additional data may be rich media that was not transmitted with the reduced record.

At step 27, the traffic sensor 200 may retrieve the requested additional data from the memory 240, and transmit it to the server system 300 for storage and retrieval by law-enforcement.

Returning to step 25, where the comparison unit 330 determines that the reduced record does not match any listed vehicle-of-interest (i.e., no “hit”), the reduced record is retained or deleted in accordance with the applicable retention period, at step 28. The traffic sensor 200 having not received the request for additional information, the recordation record is also retained or deleted from the memory 240 in accordance with the applicable retention period (e.g., after 30 days).

In this manner, the operational load on the communications infrastructure of the traffic monitoring system is reduced, while retaining the ability to provide data intensive information such as expanded images and video data to law-enforcement on an as-needed basis.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A traffic monitoring system, comprising:
a traffic sensor including:
an imaging unit configured to generate a recognition record by image recognition processing a captured image of a vehicle, wherein the recognition record includes primary data and additional data, and
a transceiver configured to transmit the primary data and the additional data to a server system, wherein the additional data is transmitted in response to a request from the server system received by the traffic sensor after the primary data is transmitted; and
the server system configured to transmit the request to the traffic sensor based on the primary data received from the traffic sensor.

2. The traffic monitoring system of claim 1,
wherein the recognition record is a data set of image recognition processing recognized values for each of a set of vehicle characteristics,
wherein the primary data corresponds to at least a first vehicle characteristic of the set of vehicle characteristics, and
wherein the additional data corresponds to at least a second vehicle characteristic of the set of vehicle characteristics.

3. The traffic monitoring system of claim 1, wherein the set of vehicle characteristics includes one or more of: vehicle type, class, make, model, color, year, drive type, registration, trajectory, speed, location and license plate number.

4. The traffic monitoring system of claim 3, wherein the first vehicle characteristic is the vehicle license plate number.

5. The traffic monitoring system of claim 3, wherein the primary data is only the vehicle license plate number.

6. The traffic monitoring system of claim 3, wherein the additional data is at least one of:
vehicle type, class, make, model, color, year, drive type hybrid, registration, trajectory, speed, and location.

7. The traffic monitoring system of claim 1, wherein the primary data is only the vehicle license plate number.

8. The traffic monitoring system of claim 1, wherein the primary data consists of the vehicle likens place number and at least one of: a timestamp of the captured image, an image of the license plate, and a limited image of the vehicle.

9. The traffic monitoring system of claim 1,
wherein the server system is further configured to compare the primary data to a stored hit list identifying one or more vehicles-of-interest, and
wherein the request is transmitted in response to the comparison indicating that the vehicle is one of the vehicles-of-interest.

10. The traffic monitoring system of claim 1, wherein the server system is further configured to ad hoc transmit the request to the traffic sensor.

11. A traffic monitoring method, comprising:
generating, at a traffic sensor, a recognition record by image recognition processing a captured image of a vehicle, wherein the recognition record includes primary data and additional data;
transmitting the primary data to a server system from the traffic sensor;
transmitting a request from the server system to the traffic sensor based on the primary data received from the traffic sensor; and
transmitting the additional data from the traffic sensor to the server system in response to the traffic sensor receiving the request from the server system.

12. The traffic monitoring method of claim 11,
wherein the recognition record is a data set of image recognition processing recognized values for each of a set of vehicle characteristics,
wherein the primary data corresponds to at least a first vehicle characteristic of the set of vehicle characteristics, and
wherein the additional data corresponds to at least a second vehicle characteristic of the set of vehicle characteristics.

13. The traffic monitoring method of claim 11, wherein the set of vehicle characteristics includes one or more of: vehicle type, class, make, model, color, year, drive type, registration, trajectory, speed, location and license plate number.

14. The traffic monitoring method of claim 13, wherein the first vehicle characteristic is the vehicle license plate number.

15. The traffic monitoring method of claim 13, wherein the primary data is only the vehicle license plate number.

16. The traffic monitoring method of claim 13, wherein the additional data is at least one of: vehicle type, class, make, model, color, year, drive type hybrid, registration, trajectory, speed, and location.

17. The traffic monitoring method of claim 11, wherein the primary data is only the vehicle license plate number.

18. The traffic monitoring method of claim 11, wherein the primary data consists of the vehicle likens place number and at least one of: a timestamp of the captured image, an image of the license plate, and a limited image of the vehicle.

19. The traffic monitoring method of claim 11, further comprising:
comparing, at the server system, the primary data to a stored hit list identifying one or more vehicles-of-interest, wherein the request is transmitted in response to the comparison indicating that the vehicle is one of the vehicles-of-interest.

20. The traffic monitoring method of claim 11, wherein the request is transmitted on an ad hoc basis.
